(19) United States
(12) Patent Application Publication
(10) Pub. No.: US 2015/0347367 A1
(43) Pub. Date: Dec. 3, 2015

(54) USER EXPERIENCE FEEDBACK RECORDER

(71) Applicant: Xerox Corporation, Norwalk, CT (US)

(72) Inventors: David Berke, London (GB); Philip James Hambridge, Hertfordshire (GB); Colin Hewitt, Hertfordshire (GB); Veena Kumari Saluja, Hertfordshire (GB); Timothy Spink, Hertfordshire (GB); Lakshmi Yaramsetti, Hertfordshire (GB)

(73) Assignee: Xerox Corporation, Norwalk, CT (US)

(21) Appl. No.: 14/291,143

(22) Filed: May 30, 2014

(51) Int. Cl. G06F 17/24; G06F 3/0484

(52) U.S. Cl. CPC G06F 17/241; G06F 3/04842

(57) ABSTRACT

Methods, systems, and computer readable media for automatically recording user experience feedback via an electronic device having or associated with a local user interface. A user experience feedback commenting module can be associated with the device to permit selection of a feedback mode utilizing a clearly marked toggle (e.g., UI soft- or hard-button) displayed on the user interface. The feedback comment about, for example, a particular device feature can be provided by the user when he or she enters data using, for example, a soft keyboard or other input feature displayed by the user interface. A user interface screen prior to switching into the feedback mode can be captured in response to activation of a screen capture option. The feedback comment can be captured in association with a reference number upon activation of a submit button and then transmitted to a collecting department or organization during a feedback collection mode.

### FIELD OF THE INVENTION

Embodiments are generally related to devices, systems, and techniques for capturing user feedback regarding a user experience. Embodiments are also related to devices such as, for example, printers, scanners, photocopy machines, and the like.

### BACKGROUND

Conventionally, customer feedback regarding the user experience is obtained by completion by a customer or user or an online form or a paper-based form. One of the problems associated with the online method is that the user must remember details regarding the transaction for which the feedback is being provided and the user is unlikely to be able to provide the feedback concurrently. Similarly, the paper-based approach requires the user to administer legible handwriting and a method of collecting and returning the feedback sheet and to remotely enter the user feedback data in a database. Users or customers do not utilize such feedback approaches extensively. Thus, valuable feedback information, which can potentially improve the quality and/or usefulness of the device or system used by the customer, never reaches the product development and/or research team. Such information would be highly useful to product designers as they continue to attempt to engineer enhanced devices and products.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for immediate user feedback at a device.

It is a further aspect of the disclosed embodiments to provide for a method and system for automatically obtaining and recording user feedback data about a particular device at the device itself via an electronic system including a user interface.

The aforementioned aspects and other objectives and advantages can now be achieved as described herein. Methods and systems are disclosed for automatically recording user experience feedback via an electronic device associated with a local user interface—a GUI (Graphic User Interface) or simply a UI (User Interface). A user experience feedback commenting module can be associated with the device to select at least one feedback mode utilizing a clearly marked toggle (e.g., a UI soft- or hard-button) displayed on the UI. A feedback comment regarding, for example, a particular device feature can be captured via a “soft” keyboard displayed by the UI.

Prior to switching into the feedback mode, the UI screen can be captured in response to activation of a screen capture option. The feedback comment can be captured with a reference number upon activation of a graphically displayed submit button and then transmitted via at least one feedback collection mode. Such an approach can result in increased quality and quantity in the user feedback obtained, as well as increased user satisfaction by letting the customer or user know that their concerns are being heard.

The feedback mode can be selected if the user is in the process of employing the feature and wishes to provide feedback. Flipping forward between the feature mode and the feedback mode can be performed multiple times as necessary to capture a series of screens leading up to an event and/or post event with feedback information being retained throughout transitions. Feedback comments can be collected based on one or more feedback collection modes and the record(s) can be deleted from the device. The feedback comment can be pushed out to a device manufacturer and/or retained on the device until retrieved by service personnel and/or an automated service process.

The feedback comment can be rendered as a permanent record with respect to the submitter/customer and the screenshot of the UI can be captured and embedded as part of the user feedback. The feedback comment can be transferred to a customer service representative local data processing unit on visiting the customer site or a remote server via a network connection. An option can also be implemented, which allows e-mailing of the submitted feedback comment in association with the unique reference number. The system thus provides an easy and efficient approach to allow for prompt feedback, which can be extended to other interaction techniques.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a device that communicates with a data-processing apparatus through a network, in accordance with a preferred embodiment;

FIG. 2 illustrates an example of a system including one or more modules for facilitating capture of user experience feedback regarding a device, in accordance with a preferred embodiment;

FIG. 3 illustrates a block diagram of a user experience feedback commenting system, in accordance with a preferred embodiment;

FIG. 4 illustrates a user interface with respect to a device depicting a feature mode and a feedback mode, in accordance with an alternative embodiment; and

FIG. 5 illustrates a high level flow chart of operations illustrating logical operational steps of a method for automatically recording a user experience feedback on an electronic device with a local user interface, in accordance with an alternative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The disclosed embodiments are described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The disclosed embodiments relate to a new approach for capturing user or customer feedback about a device or related system via the device itself. It can be appreciated that such a device may be any type of electronic apparatus or system employed by a user or customer to accomplish a particular task. Examples include devices or systems utilized in a variety of settings and applications ranging from, for example, vending machines to computing devices to photo copy machines or multi-function devices. For illustrative purposes only, the embodiment(s) discussed herein are shown in the context of an MFD (Multi-Function Device), but it can be appreciated that such embodiments are presented for exemplary purposes only and are not considered limiting features of the overall concept(s) discussed herein.

Thus, an MFD is not a limiting feature of the disclosed embodiments, but merely one of many possible devices about which feedback can be captured. Instead of an MFD, for example, device 140 may be another electronic device such as a television, vending machine, even a smartphone or table computing device. In the case of a copier/printer device such as an MFD, the feedback can be printed as a permanent record for the submitter/customer. As will be discussed in greater derail herein, screenshots of the user interface can be captured by the user and embedded as part of the user feedback.

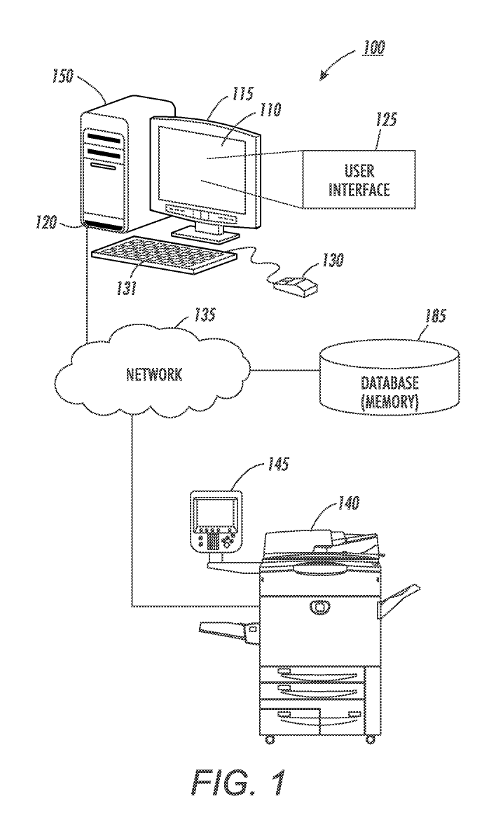

Referring to FIG. 1, system 100 can be configured to include one or more networked devices, such as device 140, which communicates with a data-processing apparatus 110 through a network 135. In some instances, the data-processing apparatus 100 may be a desktop type computer, but in other applications, the data-processing apparatus may be a server or other computing device (e.g., a tablet computing device, a laptop computer, a smartphone, etc.). In the example shown in FIG. 1, however, the data-processing apparatus 110 can be implemented as a device that includes a central processor or processing unit 120, a display device 115 (e.g., a monitor), a keyboard 131, and a pointing device 130 (e.g., a mouse, trackpad, etc.).

In the example embodiment shown in FIG. 1, the data-processing apparatus 110 can communicate with the MFD 140 (and/or other devices) through a network 135. It can be appreciated that network 135 may employ any network topology, transmission medium, or network protocol. The network 135 may include connections, such as wired communications links (e.g., fiber obtic cables) and/or wireless communication links (e.g., cellular, WiFi, Bluetooth, etc.). In the depicted example, network 135 can be the Internet representing a worldwide collection of networks and gateways that use the Transmission Control Protocol/Internet Protocol (TCP/IP) suite of protocols to communicate with one another. Network 135 can communicate electronically with a database 185 (e.g., a memory location), which may be a standalone database (e.g., located in a different server or a series of other servers or locations) or can be associated with or located in a memory location of the data-processing unit 110 or other devices.

The device 140 is associated with a user interface 145, which may offer a panel menu and/or a GUI. The panel menu may be used to select features and enter other data in the device 140. Such interfaces may include, for example, touch screens having touch activated keys for navigating through an option menu or the like. A driver program, for example, can be installed on the data-processing apparatus 110 and can reside on the host device's hard drive 150. The driver program may be activated through an application interface so that a user may generate a rendering job with the driver for processing by the MFD 140.

The user interface 145 is capable of displaying a GUI for communicating features for processing, for example, the rendering job to a user and accepting the user's selection of available rendering features. Such a GUI can also allow a customer or user of the device 140 to provide feedback about the device 140, as wall be explained in greater detail herein. The UI 145 can display information and data for a user. Such a UI also serves to display results, whereupon a user may supply additional inputs or terminate a given session.

The UI 145 may be, for example, a local user interface, such as a touch-screen display or separate keypad and display or a memory fob or the like. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. In some embodiments, a user's or customer's PDA (Personal Digital Assistant), Smartphone, tablet computing device, etc., may communicate with the UI via wireless communications (e.g., Bluetooth).

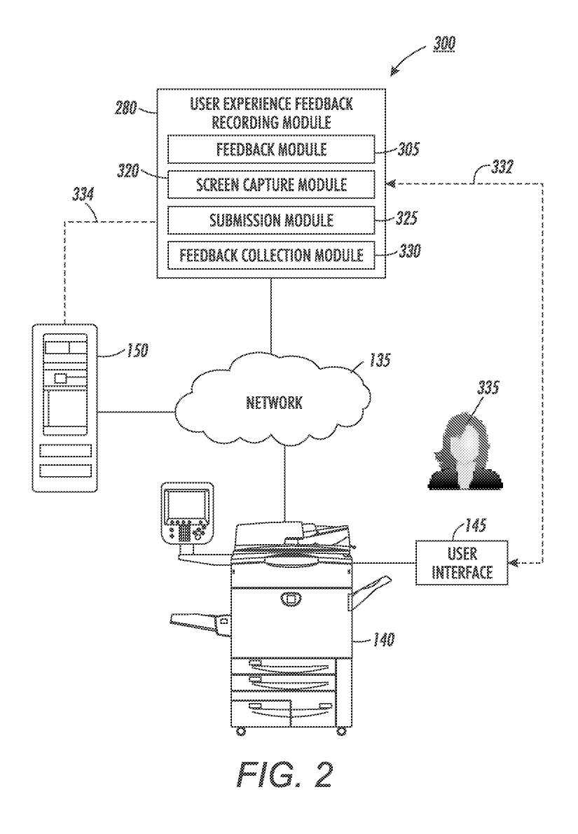

FIG. 2 illustrates an example of a system 300 including one or more modules for facilitating capture of user experience feedback regarding a device or a device feature, in accordance with a preferred embodiment. As shown in FIG. 2, a user experience feedback recording module 280 can be associated with a server 150 and/or the user interface 145. That is, module 280 may be stored on server 150 as a software module or can be stored at the user interface 145 or elsewhere. In some embodiments, module 280 may be retrieved from server 150 or another location as a software application and implemented via user interface 145. The dashed line 332 thus indicates that the module 280 may be associated with the user interface 145 (e.g., located at the user interface or retrievable via the network 135). Similarly, the dashed line 334 shown in FIG. 2 indicates that the module 280 can be associated with the server 150 and can be retrieved from the server 150 via network 135. In a preferred embodiment, module 280 is provided via UI 145 in the context of a local UI.

Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The disclosed embodiments are capable of being distributed as a program product in a variety of forms, which apply equally regardless of the particular type of signal-bearing media utilized to carry out the distribution. Examples of signal-bearing media can include, for example, recordable-type media, such as USB drives, hard disk drives, CD ROMs, CD-Rs, etc., and transmission media, such as digital and/or analog communication links and/or wireless communications means (e.g., WiFi, cellular, Bluetooth, etc.).

System 300 can thus be implemented as a user experience feedback commenting system 300 and include the user experience feedback commenting module 280 in association with the device 140 for automatically recording a user experience feedback on the device 140 associated with the local user interface 145. The user experience feedback commenting module 280 can further include sub-modules such as, for example, a feedback module 305, a screen capture module 320, a submission module 325, and a feedback collection module 330. A symbolic “user” 335 is shown in FIG. 2 with respect to, for example, UI 145. The user 335 can thus provide immediate feedback via user interfacer 145 as will be discussed in greater detail herein.

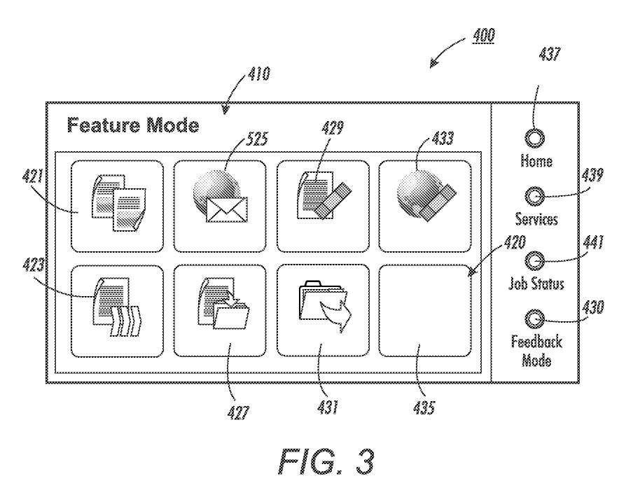

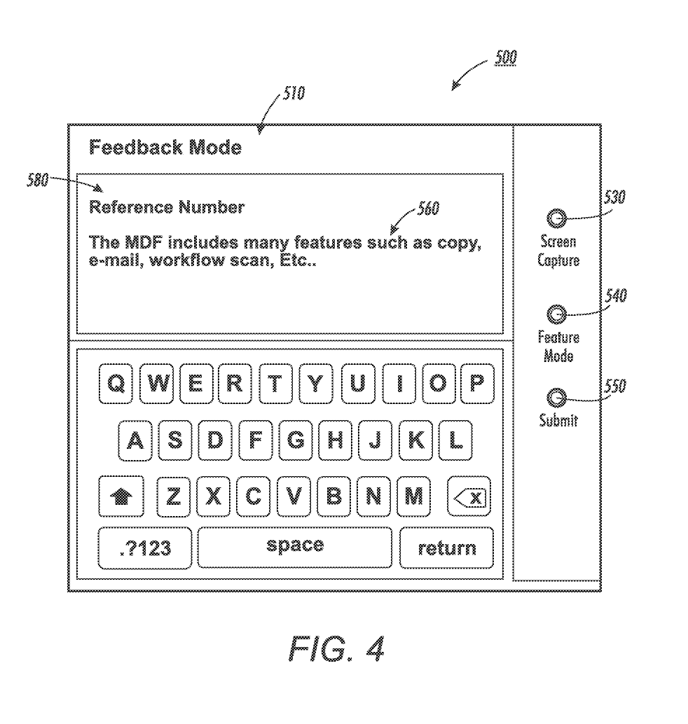

FIG. 3 illustrates a user interface 400 (e.g., a GUI) with respect to the device 140 depicting the feature mode 410, in accordance with an alternative embodiment. Note, however, although alternative embodiments are discussed herein, like parts or components are generally referred to herein by identical reference numerals. Thus, in the particular embodiment shown in FIG. 3, the feedback module 305 that was shown in FIG. 2 can display a feature mode 410 that includes a plurality of graphically displayed interactive buttons 420. Such interactive buttons 420 may be implemented as UI “soft” buttons. At the left hand side of the feature mode 410, a group of “hard” buttons can be provided, including, for example, a “home” button 437, a “services” button 439, a “job status” button 441, and a button 430 that when touched, activates a feedback mode (which is shown in FIG. 4 as feedback mode 510).

FIG. 4 illustrates the GUI 500 for displaying the feedback mode 510, in accordance with an alternative embodiment. In general, the feedback mode 510 includes the display of a reference number 580 and a section 560 in which the user can provide his or her feedback regarding the device 140. The feedback mode 510 can be selected by a user utilizing a clearly marked toggle UI soft button such as one or more of buttons 420 and/or the hard button 430 displayed via feature mode 410 of the user interface 400 shown in FIG. 3. The feedback mode 510 can be selected if the user or customer is in the process of using the device 140 and wishes to provide immediate feedback.

Note that the GUI 400 and 500 can be implemented utilizing a GUI such as, for example, the local user interface 145 and as previously explained, may be provided by a module, such as, for example, module 280 (i.e., a software application). In the illustrated figures herein, the depicted GUI 400 and 500 can be implemented in the context of a GUI “window”. Note that in computing, a GUI window is a visual area containing some type of graphically displayed user interface. Such a “window” usually (but not always) possesses a particular shape, and displays the output of and may allow input to one or more processes. A user can interact with the user interfaces 400 and 500 to select and activate particular features and options by pointing and clicking with a user input device such as, for example, a touch screen, a keyboard or the like. A particular item can function in the same manner to the user in all applications because the user interface provides standard software routines to handle these elements and reports the user's actions.

The user interface 400 with respect to the device 140 can include the soft feedback buttons 420 and/or the hard feedback buttons such as buttons 430, etc. In some embodiments, one or more “soft” buttons can be located alongside a display device, wherein the button invokes a function described by the text at that moment shown adjacent to the button on the display. Hard button is a “contrary” term, which refers to a hard-coded key such as a number key pad or, for example, the send/end key of a mobile phone or other device. The feedback buttons 420 and 430 can be activated by a user when the user decides to provide feedback with respect to the device 140.

The feedback module 305 can display a soft keyboard on the user interface 500 to provide a feedback comment 560 with respect to a feature associated with the device 140 by typing on the graphically displayed soft keyboard of the feedback mode 510. The keyboard is typically displayed via GUI 500 upon activation of the feedback mode 510 via the feedback mode button 430 shown in FIG. 3. The soft keyboard (sometimes referred to as an onscreen keyboard or software keyboard) is a system that replaces the hardware keyboard on a computing device with an on-screen image map. With a soft keyboard, data can be entered by tapping keys on the keyboard display, in some cases with a stylus, so that accuracy depends only on hitting the right key.

The screen capture module 320 shown in FIG. 2 can be activated by pressing the screen capture button 530 shown in FIG. 4. The screen capture module 320 captures the user interface screen 400 prior to switching into the feedback mode 510, in response to activation of the screen capture button 530. The submission module 325 and the feedback collection module 330 capture the feedback comment(s) 560 with a reference number 580 upon activation of a submit button 550 and transmits to at least one feedback collection mode. If further screenshots are required, the user can flip back to the feature mode 410 by pressing a feature mode button 540, continue using the feature and then flip back to the feedback mode 510. Flipping forward between feature and feedback mode 410 and 510 can be accomplished multiple times as necessary to capture a series of screens leading up to an event and/or post event with feedback information being retained throughout these transitions.

Note that the scope of the disclosed embodiments is not limited to “leading up to” an event. That is, the scope is sufficiently wide to allow screens/feedback to be captured post event (after the event) not merely “leading up to the event,” as some of the anomalies may only be seen post the occurrence of an event. An event can be determined, for example, if any knock-on anomalies of an initial event are considered as part of the event for which feedback can be captured. For example, a paper jam could be an event but a graphical screen that is portrayed incorrectly post the paper jam in the event for which feedback is required.

The feedback comment 560 can either be pushed out to a device manufacturer or retained on the device 140 until retrieved by a service personnel and/or an automated service process. The feedback comment 560 can be rendered as a permanent record for the submitter/customer and the screenshot of the user interface 500 can be captured by the user 335 and embedded as part of the user feedback. The feedback comment 560 can be transferred to a customer service representative local computer on visiting the customer site.

The feedback comment 560 can be transferred to the remote server 150 via the network connection 135. An option can also be provided to email the submitted feedback comment 560 (limited send to supplier/manufacturer only to maintain integrity) with the unique reference number 580. The system 300 provides increased quality and quantity of user feedback, as well as increased user satisfaction by letting the customer know their concerns are being heard.

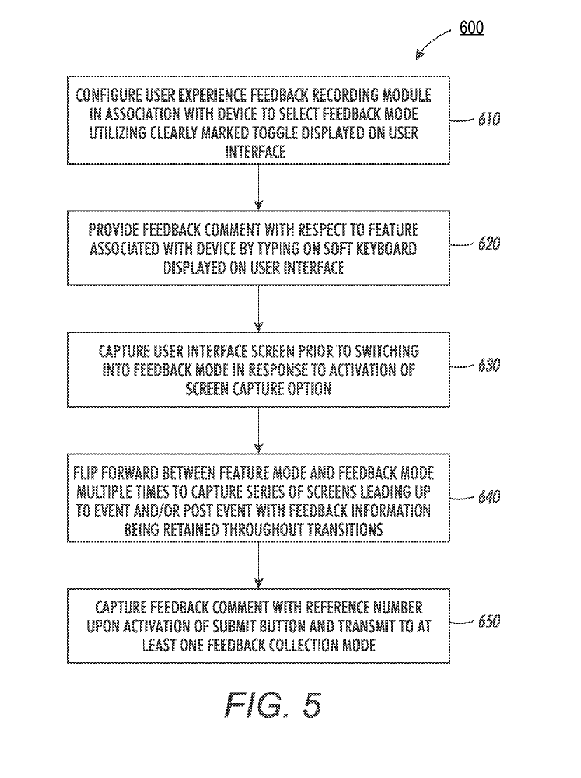

FIG. 5 illustrates a high level flow chart of operations illustrating logical operational steps of a method 600 for automatically recording user experience feedback via an electronic device such as device 140 utilizing a local user interface 145, in accordance with an alternative embodiment. As indicated at block 610, a step or logical operation can be implemented in which the user experience feedback recording/commenting module 280 associated with the device 140 so as to permit a user to select the feedback mode 510 utilizing a clearly marked toggle button, such as, for example, UI soft- or hard-buttons 420 and 430 displayed on a user interface (e.g., UI 400).

Thereafter, as depicted at block 620, a step or logical operation can be implemented in which feedback comments (e.g., see feedback comment 560) are provided with respect to feature(s) associated with the device 140 by typing on the soft keyboard displayed via the user interface 500. Then, as illustrated at block 630, the user interface screen 400 prior to switching into the feedback mode 510 can be captured in response to invoking screen capture via the screen capture button 530. Next, as described at block 640, a step or operation can be provided that allows flipping forward between respective feature and feedback modes 410 and 510, which can be accomplished multiple times and/or as necessary to capture a series of screens leading up to an event and/or post event with feedback information retained throughout such transitions. Thereafter, as depicted at block 650, feedback comment(s) 560 can be captured (in association with the reference number 580) in response to selection of the submit button 550 and transmitted to at least one feedback collection mode.

The user experience feedback commenting approach described herein is easily accessible from the normal operating interface of the device 140. In addition, the embodiments herein can place the feedback comments) 560 into an electronic format so such comments can quickly and easily be transmitted from the device 140 to many departments within the corporation that manufacture the device 140. Transmission of such feedback comments can occur via, for example, network 135 for storage in database 185. The data-processing system 100 and/or the server 150 may be located at, for example, the organization or department responsible for collecting, organizing, and analyzing the results of customer feedback. The embodiments herein do not require extensive use or knowledge of the specific device in question, which enables the feedback to be obtained from novice and expert users alike. The system 300, for example, provides an easy and efficient approach for offering prompt feedback, which can be extended to other interactions beyond simply typing.

The disclosed approach thus allows users to provide feedback on electronic devices with local user interfaces while at the device 140, using that interface (e.g, UI 145), which can then be automatically or manually retrieved for analysis and response. Users can switch into a feedback mode (e.g., feedback mode 510) using a clearly marked toggle (UI soft- or hard-button) and be prompted to leave their feedback along with a capture of the screen or screens that they were on previous to switching to feedback mode, with multiple switches supported to capture a series of screens leading up to an event and/or post event (i.e. after the event). After entry is complete, this data can be either pushed out to the device manufacturer via network 135 or retained on the device 140 until retrieved by service personnel, automated service processes or other methods. The customer or user can also be provided with option to e-mail or print the feedback they provide (if the device supports printing).

Based on the foregoing, it can be appreciated that a number of embodiments, preferred and alternative, are disclosed herein. For example, in one embodiment, a method can be implemented for automatically recording a user experience feedback. Such a method can include the steps or logical operations of, for example, associating a feedback commenting module with a device so as to offer selection of a feedback mode via a toggle displayable by a user interface; providing a feedback comment with respect to at least one feature associated with the device via the user interface; and collecting the feedback comment in association with a particular reference number via at least one feedback collection mode for recording of the user experience feedback.

In another embodiment, a step or logical operation can be provided for capturing a user interface screen prior to switching into the feedback mode in response to invoking a screen capture option. In still another embodiment, a step or logical operation can be implemented for transitioning between the feature mode and the feedback mode so as to capture a series of screens leading up to a particular event and/or post the particular event with the feedback comment being retained throughout the transition. In yet another embodiment, the step or logical operation of collecting the feedback comment can further involve collecting the feedback comment based on the at least one collection mode. In still another embodiment, the step or logical operation of collecting the feedback comment can further include steps or logical operations for deleting the feedback comment from the device.

In another embodiment, steps or logical operations can be provided for pushing the feedback comment to a manufacture of the device; and/or retaining the feedback comment on the device until retrieved by a service personnel and/or an automated service process. In still another embodiment, a step or logical operation can be provided for transferring the feedback comment and a screenshot of the user interface to at least one of the following: a customer service representative data processing unit; a remote server; or a multi-function device capable of rendering the feedback comment.

In another embodiment, a step or logical operation can be implemented for graphically displaying an option that when selected permits emailing of the feedback comment in association with the particular reference number. In still another embodiment, the aforementioned device can be, for example, a multi-function device; a computing device, a mobile communications device; a hand held computing device, etc.

In another embodiment, a system can be implemented for automatically recording a user experience feedback. Such a system can include, for example, a processor and a computer-readable medium configured to store instructions, that when executed by the processor, cause the computing device to perform the instructions or one or more functions comprising: associating a feedback commenting module with a device so as to offer selection of a feedback mode via a toggle displayable by a user interface; providing a feedback comment with respect to at least one feature associated with the device via the user interface; and collecting the feedback comment in association with a particular reference number via at least one feedback collection mode for recording of the user experience feedback.

In another embodiment, such instructions can be further configured for capturing a user interface screen prior to switching into the feedback mode in response to invoking a screen capture option. In still another embodiment, such instructions can be further configured for transitioning between the feature mode and the feedback mode so as to capture a series of screens leading up to a particular event and/or post the particular event with the feedback comment being retained throughout the transition.

In still another embodiment, the aforementioned instructions for collecting the feedback comment can further include instructions configured for collecting the feedback comment based on the at least one collection mode; and/or deleting the feedback comment from the device. In yet another embodiment, such instructions can be further configured for pushing the feedback comment to a manufacture of the device; and/or retaining the feedback comment on the device until retrieved by a service personnel and/or an automated service process.

In another embodiment, such instructions can be further configured for transferring the feedback comment and a screenshot of the user interface to, for example, a customer service representative data processing unit, a remote server, a multi-function device capable of rendering the feedback comment, etc. In yet another embodiment, such instructions can be further configured for graphically displaying an option that when selected permits emailing of the feedback comment in association with the particular reference number. In another embodiment, the aforementioned device can be, for example, a multi-function device, a computing device, a mobile communications device, a hand held computing device, etc.

In another embodiment, a computer readable medium having stored therein instructions for automatically recording a user experience feedback, that when executed by a client device, cause the client device to perform functions including, for example: associating a feedback commenting module with a device so as to offer selection of a feedback mode via a toggle displayable by a user interface; providing a feedback comment with respect to at least one feature associated with the device via the user interface; and collecting the feedback comment in association with a particular reference number via at least one feedback collection mode for recording of the user experience feedback.

In another embodiment, such functions can further include, for example, capturing a user interface screen prior to switching into the feedback mode in response to invoking a screen capture option; and/or transitioning forward between the feature mode and the feedback mode so as to capture a series of screens leading up to a particular event and/or post the particular event with the feedback comment being retained throughout the transition. In yet other embodiments, such functions can include; for example, the various instructions or steps mentioned previously herein.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for automatically recording a user experience feedback, said method comprising:
associating a feedback commenting module with a device so as to offer selection of a feedback mode via a toggle displayable by a user interface;
providing a feedback comment with respect to at least one feature associated with said device via said user interface; and
collecting said feedback comment in association with a particular reference number via at least one feedback collection mode for recording of said user experience feedback.

2. The method of claim 1 further comprising capturing a user interface screen prior to switching into said feedback mode in response to invoking a screen capture option.

3. The method of claim 1 further comprising transitioning forward between said feature mode and said feedback mode so as to capture a series of screens leading up to a particular event and/or post said particular event with said feedback comment being retained throughout said transition.

4. The method of claim 1 wherein collecting said feedback comment further comprises collecting said feedback comment based on said at least one collection mode.

5. The method of claim 1 wherein collecting said feedback comment further comprises deleting said feedback comment from said device.

6. The method of claim 1 wherein collecting said feedback comment further comprises:
collecting said feedback comment based on said at least one collection mode; and
deleting said feedback comment from said device.

7. The method of claim 1 further comprising:
pushing said feedback comment to a manufacture of said device; or
retaining said feedback comment on said device until retrieved by a service personnel and/or an automated service process.

8. The method of claim 1 further comprising transferring said feedback comment and a screenshot of said user interface to at least one of the following:
a customer service representative data processing unit;
a remote server; or
a multi-function device capable of rendering said feedback comment.

9. The method of claim 1 further comprising graphically displaying an option that when selected permits emailing of said feedback comment in association with said particular reference number.

10. The method of claim 1 wherein said device comprises at least one of the following types of devices:
a multi-function device;
a mobile communications device; and
a hand held computing device.

11. A system for automatically recording a user experience feedback, said system comprising:
a processor; and
a computer-readable medium, configured to store instructions, that when executed by the processor, cause the computing device to perform said instructions comprising:
associating a feedback commenting module with a device so as to offer selection of a feedback mode via a toggle displayable by a user interface;
providing a feedback comment with respect to at least one feature associated with said device via said user interface; and
collecting said feedback comment in association with a particular reference number via at least one feedback collection mode for recording of said user experience feedback.

12. The system of claim 11 wherein said instructions are further configured for capturing a user interface screen prior to switching into said feedback mode in response to invoking a screen capture option.

13. The system of claim 11 wherein said instructions are further configured for transitioning forward between said feature mode and said feedback mode so as to capture a series of screens leading up to a particular event and/or post said particular event with said feedback comment being retained throughout said transition.

14. The system of claim 11 wherein said instructions for collecting said feedback comment, further comprise instructions configured for:
collecting said feedback comment based on said at least one collection mode; and
deleting said feedback comment from said device.

15. The system of claim 11 wherein said instructions are further configured for:
pushing said feedback comment to a manufacture of said device: or
retaining said feedback comment on said device until retrieved by a service personnel and/or an automated service process.

16. The system of claim 11 wherein said instructions are further configured for transferring said feedback comment and a screenshot of said user interface to at least one of the following:
a customer service representative data processing unit;
a remote server; or
a multi-function device capable of rendering said feedback comment.

17. The system of claim 11 wherein said instructions are further configured for graphically displaying an option that when selected permits em ling of said feedback comment in association with said particular reference number.

18. The system of claim 11 wherein said device comprises at least one of the following types of devices:
a multi-function device;
a mobile communications device; and
a hand held computing device.

19. A computer readable medium having stored therein instructions for automatically recording a user experience feedback, that when executed by a client device, cause said client device to perform functions comprising:
associating a feedback commenting module with a device so as to offer selection of a feedback mode via a toggle displayable by a user interface;
providing a feedback comment with respect to at least one feature associated with said device via said user interface; and
collecting said feedback comment in association with a particular reference number via at least one feedback collection mode for recording of said user experience feedback.

20. The computer-readable medium of claim 19, wherein the functions further comprise:
capturing a user interface screen prior to switching into said feedback mode in response to invoking a screen capture option; and
transitioning forward between said feature mode and said feedback mode so as to capture a series of screens leading up to a particular event and/or post said particular event with said feedback comment being retained throughout said transition.
